(19) United States
(12) Patent Application Publication
(10) Pub. No.: US 2012/0005149 A1
(43) Pub. Date: Jan. 5, 2012

(54) EVIDENTIAL REASONING TO ENHANCE FEATURE-AIDED TRACKING

(75) Inventors: Yang CHEN, Westlake Village, CA (US); Barbara J. Blyth, Ellington, CT (US)

(73) Assignee: Raytheon Company, Waltham, MA (US)

(21) Appl. No.: 12/827,858

(22) Filed: Jun. 30, 2010

(51) Int. Cl. G06N 7/02

(52) U.S. Cl. 706/52

(57) ABSTRACT

A process and system for enhancing tracking of one or more physical objects of interest within a search area updates track scores according to evidential reasoning. Predetermined information related to the underlying problem is stored in memory. An intermediate processor in communication between a tracking application and a reasoning engine determines for each tracked object of interest, a respective belief function, assigns an initial degree of belief, such that a component of the initial degree of belief is indicative of ignorance. Each respective belief function is forwarded to the reasoning engine. Further predetermined information related to the underlying problem indicative of a fusion network is also stored in memory and accessible to the reasoning engine. A belief supporting a respective identity for each of at least one tracked objects of interest is determined by the reasoning engine and returned to the tracking application through the intermediate processor.

### TECHNICAL FIELD

Various embodiments are described herein relating generally to ingest module enhancements to enhance tracking for applications including radar systems, sonar systems and the like, and more particular to feature-aided tracking using Dempster-Shafer evidential reasoning.

### BACKGROUND

Technological advancements in processing speed, networking, and storage capacity have enabled new automated solutions to increasingly complex problems. One such class of problems relates to systems that arrive at a sophisticated awareness of their physical surroundings without requiring human intervention—at least during runtime. Such systems are applicable to machine vision, security monitoring, and more generally to surveillance. Automated surveillance, particularly in military applications, has made use of a wide variety of sensors that make observations of their surrounding environments. Some examples include RADAR, sonar, LIDAR, infrared, and video sensing. Other examples include electronic surveillance measures (ESM) and interrogator type systems, such as identification friend-or-foe (IFF), allowing an interrogator to distinguish friendly aircraft, vehicles, or forces.

Reports generated by such sensors (e.g., a RADAR plot) may provide a range, bearing and perhaps altitude of a target. Such reports can be processed to provide additional information. One such category of processors referred to as tracking processors, or trackers, receive consecutive update observation reports from one or more sensors and associates any such reports that belong to the same target into respective tracks. Additional information can be determined from the associated reports, such as a target's position, bearing, speed, acceleration, and altitude, referred to generally as kinematics. Surveillance systems, such as RADAR may include a sensor integrated with such a tracking processor.

In determining associations of updated sensor reports, tracking applications may compute track scores as a measure of association of an updated report with an existing track. Traditional tracking applications are based on track kinematics and are known to perform poorly in dense target environments. Unfortunately, kinematics alone will likely be insufficient to disambiguate incorrect associations. For example, it may be very difficult if not impossible to distinguish two targets with similar kinematics—consider vehicles traveling in formations, or convoys. If some members of the group join or leave the group it may be impossible from sensor reports alone to discern which members are involved. A subclass of tracking process is referred to as a multiple hypothesis tracker (MHT). MHT trackers use track scores (e.g., log likelihoods) to rank data association alternatives during MHT processing. Track scores based on target features (both signatures and classifications) can enhance a trackers capability in keeping a target in track because targets in proximity may have unique sensor signature characteristics or belong to different target class. These features help disambiguate potential data associations that can not be resolved by kinematics alone.

### SUMMARY

Described herein are embodiments of systems and techniques for processing information received from one or more sensors configured to observe objects of interest, such information processing enhances track performance according to classification of the observed objects of interest. In particular embodiments, information fusion is employed to substantially reduce or eliminate at least some of the disadvantages and problems associated with previous methods and systems for processing such information. Information fusion is a process for associating, correlating, and combining data and information from one or more sources to achieve refined estimates of target type, classification, nationality, allegiance and intent for observed entities. Accordingly, information fusion techniques combining data from multiple sources are employed to achieve improved accuracies and more specific inferences regarding the observed entities. Beneficially, information fusion can provide improved decision-making in rapidly changing environments in which imperfect data is provided by multiple sources.

In one aspect, at least one embodiment described herein supports a process for use in tracking physical objects of interest within a search area. More particularly, the process comprises receiving evidence related to at least one tracked object of interest. Received evidence is encoded within the Ingest Modules into a respective belief function for each of the at least one tracked objects of interest. An initial degree of belief is assigned to each respective belief function, with a component of the initial degree of belief being indicative of ignorance. For each of the at least one tracked objects of interest, the respective belief function along with the assigned degree of belief is forwarded to an evidential reasoning engine. A belief supporting a respective identity for each of the at least one tracked objects of interest is updated, for example, by the evidential reasoning engine.

In some embodiments, determining a respective belief function further comprises accessing predetermined information relating to one or more of: at least one system variable indicative of each tracked object of interest; a plurality of respective states available for association with each of the at least one system variables; a respective type characterization for the received evidence; an a priori characterization of the evidence; and an indication of preferred method for encoding the received evidence.

In some embodiments, the process further comprises initially storing the predetermined information in an electronic memory.

In some embodiments, the stored information comprises a conditional probability table.

In some embodiments, the stored information comprises a one-to-many structure adapted to provide an equivalence class for association with the received evidence.

In some embodiments, the process further includes receiving in a format native to a requestor, a request for processing by a separate evidential reasoning engine at least one tracked object of interest; re-formatting the request, as required, according to a format native to the evidential reasoning engine; populating the reformatted request with the respective belief function along with the assigned degree of belief; and forwarding the re-formatted, populated request to the evidential reasoning engine for further processing.

In some embodiments the request for processing comprises a request for computation of a conflict between two of the at least one tracked objects of interest.

In some embodiments the request for processing comprises request for merging together into a single tracked object of interest at least two of the at least one tracked objects of interest.

In some embodiments, the process further includes maintaining a list of at least one tracked object of interest.

In some embodiments forwarding the respective belief function along with the assigned degree of belief to the evidential reasoning kernel, also referred to as the evidential reasoning engine comprises using a TCP/IP socket between the ingest modules and the evidential reasoning engine.

In some embodiments, the process further includes discounting the initial degree of belief assigned to each respective belief function. In some embodiments, the process further includes determining, upon request, a conflict between every pair of tracked physical objects of interest. The conflict, for example, can be determined between the encoded belief functions.

In another aspect, at least one embodiment described herein relates to a system for providing feedback to a track processor to enhance tracking of one or more physical objects of interest within a search area by providing feedback to the track processor. The system comprises a first electronic memory configurable with predetermined information and an intermediate processor in communication with the first electronic memory. The intermediate processor is adapted to receive evidence related to at least one tracked object of interest. The intermediate processor is also adapted to determine for each of the at least one tracked objects of interest, a respective belief function, and to assign an initial degree of belief to each respective belief function, such that a component of the initial degree of belief is indicative of ignorance. The system includes a second electronic memory configurable with predetermined information relating to a fusion network and an evidential reasoning engine in communication with the intermediate processor and the second electronic memory. The evidential reasoning engine is adapted for each of the at least one tracked objects of interest, to receive from the intermediate processor the respective belief function along with the assigned degree of belief and in response, to update a belief supporting a respective identity for each of at least one tracked objects of interest.

In some embodiments, the system further includes an application program interface adapted to coordinate requests for processing of the at least one tracked object of interest by the evidential reasoning engine, in a format native to a requestor of the processing.

In some embodiments, the evidential reasoning engine includes evidential reasoning according to the Dempster-Shafer theory of evidence.

In some embodiments, each of the intermediate processor and the evidential reasoning engine comprise a respective TCP/IP socket for communicating there between.

In some embodiments, the system further includes network connectivity between the intermediate processor and the evidential reasoning engine.

In another aspect, at least one embodiment described herein relates to a system for enhancing tracking of one or more physical objects of interest within a search area. The system comprises means for receiving evidence related to at least one tracked object of interest, means for encoding received evidence into a respective belief function for each of the at least one tracked objects of interest; means for assigning an initial degree of belief to each respective belief function, a component of the initial degree of belief being indicative of ignorance, means for discounting beliefs and means for forwarding the respective belief function along with the assigned degree of belief, collectively referred to as beliefs, to an evidential reasoning engine for combination and accumulation of beliefs for each of the at least one tracked objects of interest, the evidential reasoning engine updating a belief supporting a respective identity for each of the at least one tracked objects of interest.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a particular embodiment of an intelligence-gathering system that includes an information aggregator and multiple sensors.

FIG. 2 illustrates a particular embodiment of the information aggregator illustrated in FIG. 1.

FIG. 3 illustrates a flowchart detailing an example operation of a particular embodiment of the information aggregator in aggregating information.

FIG. 4 illustrates a functional block diagram of a particular embodiment of a classification assisted tracking architecture.

FIG. 5 illustrates a flowchart detailing an example operation of initialization phase of a particular embodiment of the information aggregator in preparation for aggregating information.

FIG. 6 illustrates a flowchart detailing an example operation of a particular embodiment of the information aggregator in aggregating information.

FIG. 7 illustrates a graphical representation of a particular embodiment of a fusion network.

FIG. 8 illustrates a graphical representation of a particular embodiment of a fusion network.

FIG. 9 illustrates tracking results of an example scenario observed by an intelligence-gathering system.

### DETAILED DESCRIPTION

A description of preferred embodiments of the invention follows.

The examples described herein are directed to track enhancement using classification features (classification-aided tracking or CAT). Target classification in such embodiments can facilitate identification, or ID, of a target. Target features that contribute to target classification are collected, in at least some instances, along with target kinematics. The state of target classification for each track is maintained using a belief function approach. One such approach is known as the Dempster-Shafer (D-S) belief theory.

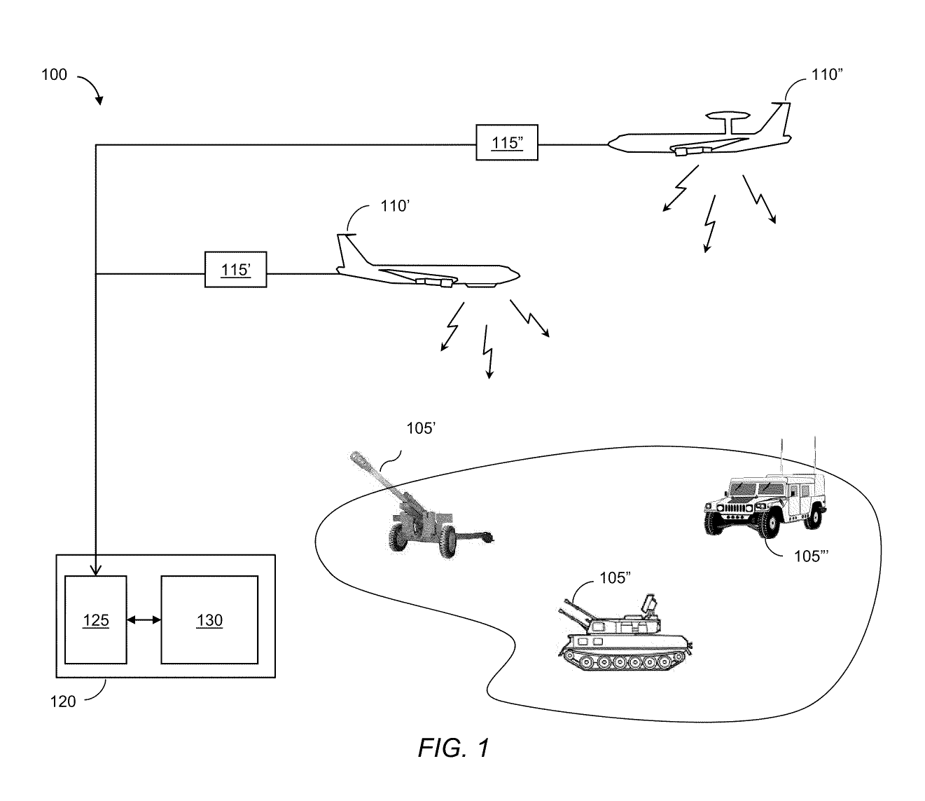

FIG. 1 illustrates a particular embodiment of an intelligence-gathering system 100 for collecting information on one or more objects of interest 105′, 105″, 105′″ (generally 105) and making determinations regarding the objects of interest 105 based on the collected information. The system 100 includes one or more sensors 110′, 110″ (generally 110) and an information aggregator 120. Each of the sensors 110 generates evidence 115′, 115″ (generally 115) relating to one or more of the objects of interest 105 and transmits the evidence 115 to the information aggregator 120. The information aggregator 120, in turn, aggregates the evidence 115 and makes decisions regarding the objects of interest 105 based on the aggregated evidence 115. New evidence 115 is provided by each sensor 110 periodically in the form of update reports.

In particular embodiments, the information aggregator 120 includes an application for tracking particular objects of interest 105, referred to generally as a tracker 125. The tracker 125 can be configured to monitor evidence 115 received over consecutive update reports from one or more of the sensors 110 and to determine those sequences of update reports belonging to the same object of interest 105. Resulting tracks can include some form of track identifier, or name, along with track-related information. Track-related information can include, for example, kinematics information (e.g., position, bearing, speed) related to the respective object of interest 105.

In some embodiments, the tracker 125 strives to provide a single track for each respective object of interest 105. For example, a multiple hypothesis tracker (MHT) 125 allows a track to be updated by evidence 115 received from more than one sensor 110 and, in turn, may spawn multiple possible tracks. As each update report is received, every possible track can be potentially updated with each new update. Over time in a multiple hypothesis tracker 125, a track can branch into many possible directions. The multiple hypothesis tracker 125 calculates a likelihood measure, such as the probability, of each potential track and typically only reports the most probable of all the tracks. The most unlikely tracks can be deleted to conserve processing resources. Multiple hypothesis trackers 125 can benefit scenarios in which motion of the objects of interest 105 is unpredictable, as in ground tracking applications.

Since objects of interest 105 (sometimes referred to as targets) can travel in groups, or cross paths, and/or operate in dense target environments, it is desirable to associate more than just kinematics with each track. In at least some embodiments, such additional information can be referred to generally as target feature, attribute and identification (ID) information. In some embodiments, the tracker 125 is combined with another application for combining target feature and/or ID information with tracks, referred to generally as an target classification processor 130. That is, two objects of interest 105 that may be traveling in close proximity, e.g., in a convoy, can be distinguished by a target feature, such as target type. For example, a scout vehicle 105′″ can be distinguished from a piece of artillery 105′. Such “type” tracking allows both tracks to be distinguished, despite close physical proximity, speed, and/or bearing.

In surveillance systems employing classification-aided tracking, track scores are based at least in part on target features, such as signatures and type classifications. Surveillance approaches using such supplemental information can enhance the performance of a tracking application by enhancing its capability to keep a target in track. Detectable differences by way of unique signature characteristics or belonging to a different target class can be used to distinguish among multiple targets in close proximity. In classification-aided tracking, target features that contribute to target classification are collected along with target kinematics to independently or collectively infer classification (i.e., identity or ID) of the target.

In particular embodiments, the information aggregator 120 implements a valuation based system for determining target classifications. In at least some embodiments, the valuation based system employs belief function theory to implement evidential reasoning, determining target classifications according to evidence 115, which may be in the form of kinematic behaviors, features, parameters, relations and attributes. Because the aggregation of significant amounts of information from multiple sources in an evidential-reasoning network can be time and resource-intensive, the system 100 can utilize certain techniques to sort and store information regarding the objects of interest 105 to efficiently combine new evidence 115 generated by sensors 110 with existing evidence stored by information aggregator 120. Although the described techniques can be applied to any suitable information-fusion system, the description below focuses, for purposes of illustration, on an example embodiment in which information from multiple sensors 110 are combined to determine the classification type of targets in a combat identification system using Dempster-Shafer evidential reasoning.

One or more of the sensors 110, such as air surveillance radar platforms 110, observe one or more of the objects of interest 105, such as ground vehicles 105, generating evidence 115 associated with the objects of interest 105, and transmitting the evidence 115 to the information aggregator 120. The sensors 110 can each represent any type of device or group of devices suitable to observe, detect, and/or monitor objects of interest 105 and generate evidence 115 pertaining to these objects of interest 105. Examples of sensors 110 include, but are not limited to, video and still cameras, motion detectors, radar systems, Electro Optical/Infrared (EO/IR), Infrared Search and Track (IRST), Doppler, sonar receivers, infrared detectors, seismometers, thermal-imaging systems, and x-ray imaging systems. More generally, however, sensors 110 can represent any appropriate combination of hardware, software, and/or encoded logic suitable to provide the described functionality. The sensors 110 can couple to the information aggregator 120 through a dedicated connection (wired or wireless) or can connect to the information aggregator only as necessary to transmit evidence 115. Although FIG. 1 illustrates for purposes of example a particular number and type of sensors 110, alternative embodiments of the system 100 can include any appropriate number and type of sensor.

The evidence 115 includes data generated by the sensors 110 and transmitted to the information aggregator 120. The evidence 115 may represent any appropriate type of data defining, describing, specifying, or otherwise indicating one or more characteristics, conditions, or occurrences associated with a particular object of interest 105. In particular embodiments, system 100 monitors a set of propositions relating to objects of interest 105. These propositions are modeled within system 100 by a set of variables, and each variable is associated with a particular set of possible values, or “states.” In such embodiments, the evidence 115 provides information regarding the state of one or more of these variables. For example, in particular embodiments, objects of interest 105 may each represent a ground vehicle and evidence 115 may indicate the size of ground vehicle (e.g., small, medium, large, extra large), whether the vehicle is an on-road or off-road vehicle, whether the vehicle is in a group or not, and/or other appropriate characteristics of the ground vehicle. Furthermore, in particular embodiments, the system 100 utilizes evidential reasoning and evidence 115 may indicate a level of belief associated with one or more states of a particular variable instead of providing a definitive determination of the relevant variable's state. The evidence 115 may represent a text file, a relational database file, a track data stream with associated attributes, or information structured, indexed, or formatted in a suitable manner. In particular embodiments, each of the sensors 110 respectively transmits evidence 115 to the information aggregator 105.

Objects of interest 105 represent vehicles (e.g., air, ground, space, marine), structures, people, creatures, or other objects monitored or detected by the sensors 110. In particular embodiments, the objects of interest 110 may represent intangible elements, such as financial instruments, natural phenomena, and computer processes. The objects of interest 105 can be associated with certain properties, states, or outcomes that the sensors 110 detect, and the intelligence-gathering system 100 can be configured to make determinations regarding the objects of interest 105 based on data generated by the sensors 110 regarding these properties, states, or outcomes. In the illustrated embodiment, the objects of interest 105 represent ground vehicles operating in a combat area.

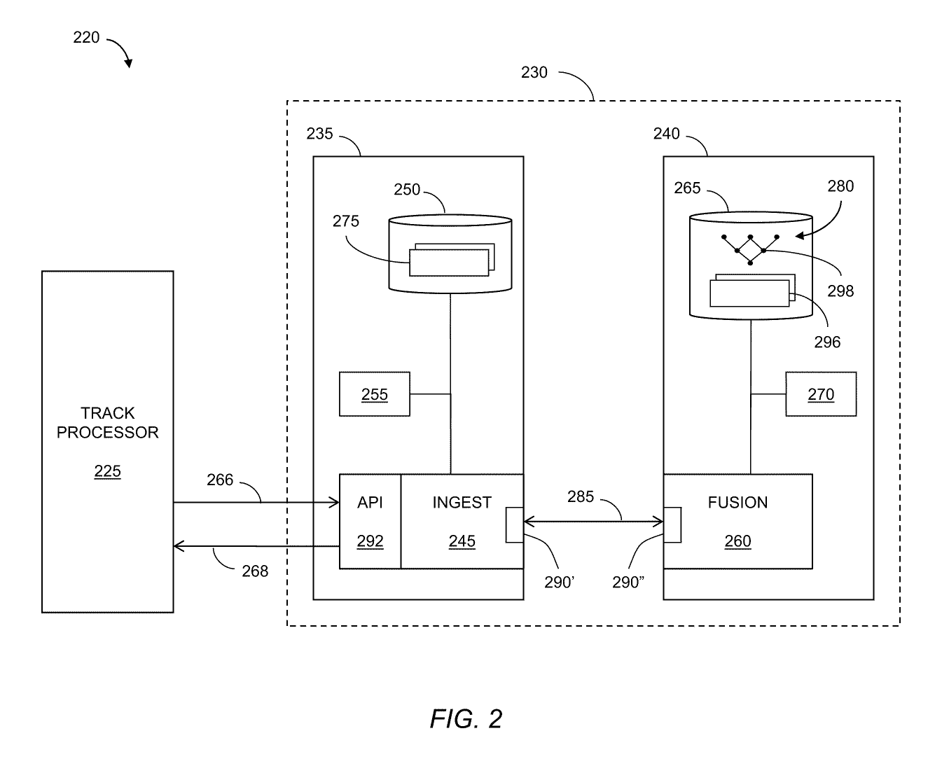

The information aggregator 120 receives respective evidence 115 from each of the sensors 110 and combines the evidence 115 with information previously stored by the information aggregator 120. Based on the aggregated information, the information aggregator 120 makes determinations relating to the objects of interest 105. The information aggregator 120 can represent any appropriate combination of hardware and/or software suitable to provide the described functionality. For example, in particular embodiments, the information aggregator 120 represents a personal computer (PC) connected to the one or more sensors 110 by a computer and/or communications network and capable of receiving data from each of the sensors 110 over the network. The contents and operation of a particular embodiment of information aggregator 120 are discussed in further detail below with respect to FIGS. 2-9.

The state of target classification for each track is maintained using a belief function approach and some rule of combination, such as the Dempster-Shafer (D-S) Rule of Combination. For a classification-aided tracking system, track scores are updated using classification information. An initial track score is determined for sensor observation update. The track score may be determined by a tracker associated with each sensor and/or a MHT, determining one or more track scores from observations received from multiple sensors. Target classification provides supplemental information that can be used to adjust or otherwise update the track score representing a refinement. For example, an adjustment to an initial track score responsive to a classification feature may be given as a log likelihood track score increment (ΔL_{F}). Such an associated track score increment can be described by the following relationship:

ΔL_{F}=I_{G}(a−b·ln(1−k)) Eq. 1

The value k in the above equation is the D-S conflict term that may be determined, for example, between a new observed feature mass function and a current state. The quantities a and b are constants adjustable, such that the final score increment resides in a desirable range. In some embodiments, the values a and b are fixed to 3.0 and 4.3, respectively. The quantity k is a multiplier to partially correct the fact that the mass functions (both the input and the system's classification output) with large ignorance mass will result in small conflict, which does not indicate a good data association. In at least some embodiments, the quantity I_{G} is described by the relationship:

I_{G}=1−m_{O}(θ)−m_{T}(θ)+m_{T}(θ)+m_{O}(θ) Eq. 2

The values m_{O}(θ) and m_{T}(θ) in the above equation represent the ignorance mass for the observation and for the current track classification state, respectively.

In operation, each of the sensors 110 monitors one or more objects of interest 105 and generates evidence 115 relating to the monitored objects of interest 105. Each item of evidence 115 generated by a sensor 110 provides information indicating, or supporting a belief, that a particular subset of variables has a particular subset of states. For example, in the illustrated embodiment, the objects of interest 105 represent ground vehicles operating in a combat area, and the sensors 110 generate evidence 115 relating to propositions that may be used to determine one or more characteristics, such as the type, class, and/or nationality of the monitored objects of interest 105.

Each sensor 110 may generate information relating to one or more of the various propositions, and different sensors 110 may generate information relating to different combinations of these propositions. For example, a first sensor 110 (e.g., sensor 110′) may generate evidence 115 indicating that a particular object of interest 105 (e.g., object of interest 105′) has a “medium” size and is “off-road,” while a second sensor 110 (e.g., sensor 110″) may generate evidence 115 supporting the same collection of propositions or a different collection of conflicting propositions such as “large” size and “off-road”. Thus, the sensor 110 may generate evidence 115 indicating a belief that object of interest 105″ is “off-road,” but indicating nothing about the size of object of interest 105″ or whether it is in a group or not. Additionally, a particular sensor 110 may provide evidence 115 supporting multiple different states for the same variable. For example, a particular sensor 110 may generate evidence indicating that object of interest 105′″ has is off-road or on-road. Thus, each element of evidence 115 generated by each of the sensors 110 provides support for a particular set, or “configuration,” of one or more states associated with one or more variables.

FIG. 2 illustrates a particular embodiment of the information aggregator illustrated in FIG. 1. In particular, an information aggregator 220 includes a track processor 225 in communication with a target classification processor 230. The target classification processor 230, in turn, includes an intermediate data processor 235 (i.e., an Ingest Module) in communication with a data fusion processor 240. The intermediate data processor 235 is responsible for taking in input evidence (e.g., reports, feature measurements and likelihood functions) and converting it into a belief function. In embodiments using D-S belief theory, the belief function can be referred to as a D-S mass function. In general, a degree of belief in a proposition is referred to as a mass and can be represented by a belief or mass function. The data fusion processor 240 receives the D-S mass function produced by the intermediate data processor 235 and combines it with previous evidence to form an updated belief about the underlying events (e.g., classification or type of a target). When the combined masses pass a threshold, then the output accumulated, normalized mass can be transformed to a pignistic measure or plausibility probability by a applying a suitable transformation.

The intermediate data processor 235 includes a data processing module 245 in communication with a first memory 250, and a first processor 255 in communication with the data processing module 245 and the first memory 250.

The data fusion processor 240 includes a data fusion module 260 in communication with a second memory 265, and a second processor 270 in communication with the data fusion module 260 and the second memory 265. In some embodiments, a portion of the retrievable record referred to as a knowledge base 275 is stored in the first memory 250. The knowledge base 275 includes stored information representing prior knowledge related to the underlying problem, e.g., the target classification problem. Likewise, a portion of the retrievable record referred to as a fusion network 280 is stored in the second memory 265. The fusion network 280 includes stored information representing relations between sources of evidence to guide the reasoning process in determining solutions to the target classification problem.

In some embodiments, the intermediate data processor 235 and the data fusion processor 240 are combined in a single unit. In at least some embodiments, the intermediate data processor 235 is in communication with the data fusion processor 240 through a communication network path 285. For example, each of the data processing module 245 and the data fusion module 260 includes a respective internet socket, such as a TCP/IP socket 290′, 290″. Accordingly, the intermediate data processor 235 can be combined together with the data fusion processor 240 or physically separate. The intermediate data processor 235 also includes an application program interface (API) 292 in communication with the track processor 225. The API 292 allows a client application, such as the track processor 225, to access functionality and services of the data fusion processor 240 thereby facilitating communication between both processors 240, 235. For example, the intermediate data processor 235 receives target features 266 from the track processor 225 and returns conflict and identification reports 268 to the track processor 225. Communication between the intermediate data processor 235 and the track processor can be coordinated through the API 292. Data fusion processor 240 native commands can be implanted by the intermediate data processor 235 as required to support coordinated system processing with the track processor 225.

The first and second processors 255, 270 may represent or include any form of processing component, including general purpose computers, dedicated microprocessors, or other processing devices capable of processing electronic information. Examples of processors 255, 270 include digital signal processors (DSPs), application-specific integrated circuits (ASICs), field-programmable gate arrays (FPGAs), and any other suitable specific- or general-purpose processors. Although FIG. 2 illustrates a particular embodiment of the intermediate data processor 235 and the data fusion processor 240 each including a single processor 255, 270, either or both of the intermediate data processor 235 and the data fusion processor 240 may include any suitable number of processors 255, 270.

The first memory 250 stores processor instructions, at least one representation of the knowledge base 275, received evidence 115 (FIG. 1), and/or other information or values that the intermediate data processor 235 may utilize during operation. In particular embodiments, the first memory 250 may also store determinations made by the target classification processor 230 for subsequent analysis. The second memory 265 stores processor instructions, at least one representation of a fusion network 280, a supporting database 296, and/or other information or values that the data fusion processor 240 may utilize during operation. The first and second memories 250, 265 may comprise any collection and arrangement of volatile or non-volatile components suitable for storing data. For example, either or both memories 250, 265 may comprise random access memory (RAM) devices, read-only memory (ROM) devices, magnetic storage devices, optical storage devices, or any other suitable data storage devices. In particular embodiments, either or both memories 250, 265 may represent, in part, computer-readable storage media on which computer instructions and/or logic are encoded. In such embodiments, some or all the described functionality of the intermediate data processor 235 may be provided by the first processor 255 executing the instructions encoded on the described media. Likewise, some or all the described functionality of the data fusion processor 240 may be provided by the second processor 270 executing the instructions encoded on the described media. Although shown in FIG. 2 as single components, either or both of the first and second memories 250, 265 may represent any number of memory elements within, local to, or accessible by the intermediate data processor 235 and the data fusion processor 240, respectively. Additionally, although shown in FIG. 2 as being located internal to the intermediate data processor 235 and the data fusion processor 240, respectively, either or both of the first and second memories 250, 265 may represent storage components remote from their respective intermediate data processor 235 and the data fusion processor 240.

The intermediate processor 235 receives evidence 115 from one or more sensors 110 (FIG. 1) and prepares evidence 115 or information extracted from evidence 115 for entry into the supporting database 296. In particular embodiments, the intermediate processor 235 may generate valuations or otherwise encode received evidence involving the variables monitored by one or more sensors 110 based on evidence 115. For example, received evidence can be encoded within the data processing module 245, also referred to as an ingest module 245. In alternative embodiments, the one or more sensors 110 may provide valuations for the relevant variable s as part of evidence 115. The intermediate processor 235 may perform any other appropriate processing to prepare evidence 115 for entry into the supporting database 296 including, but not limited to, formatting, normalizing, filtering, and verifying evidence 115.

The data fusion module 260 includes reasoning functionality that inserts information output by the intermediate data processor 235 into the supporting database 296. In particular embodiments, the reasoning functionality is configured to utilize Dempster-Shafer reasoning algorithms to insert information into a binary join tree. As a result, in particular embodiments, reasoning functionality of the data fusion module 260 applies Dempster's Rule of Combination and propagates the new information through the nodes 298 of the fusion network, (also referred to as join tree 280). Additionally, in such embodiments, the reasoning functionality generates valuations generated by the intermediate data processor 235 and stores these in ordered lists to facilitate the combination operation. Reasoning functionality of the data fusion module 260 may also combine valuations associated with various nodes of a join tree 280 to facilitate fusion of evidence 115.

The data fusion module 260 also includes decision-making functionality makes decisions regarding objects of interest 110 based on information stored in the database 296. In particular embodiments, decision-making functionality of the data fusion module 260 may make such decisions in response to determining that a belief value associated with a particular valuation or valuations in the join tree 280 exceeds a particular threshold level. The decision-making functionality may utilize the information in database 296 to make any appropriate determinations. For example, in particular embodiments, the target classification processor 230 may represent part of a combat identification system, and decision-making functionality of the data fusion module 260 may determine classification types of object of interests 110 based on correlations with information in the a-priori database 296.

In general, each of the data processing module 245 and the data fusion module 260 with reasoning and decision making functionality may represent any appropriate combination of hardware and/or software suitable to provide the described functionality. Additionally, any two or more of the data processing module 245, the data fusion module 260 may represent or include common elements. In particular embodiments, the data processing module 245, the data fusion module 260 represent, in part, software applications being executed by one or more of the first and second processors 255, 270.

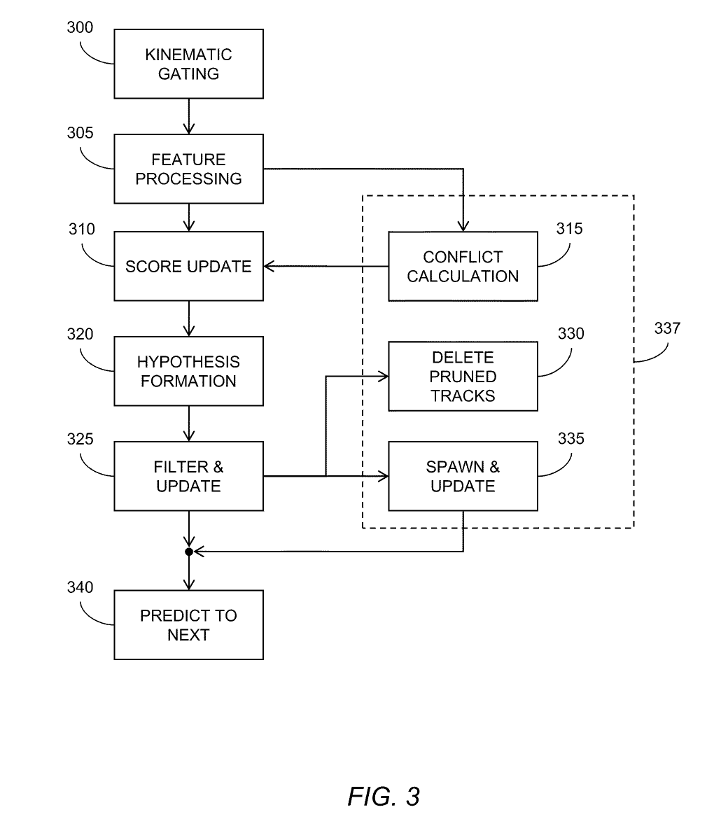

A flowchart detailing an example operation of a particular embodiment of the information aggregator in aggregating information is illustrated in FIG. 3. Each updated sensor observation can be processed by an MHT tracker to update existing tracks, identify new tracks and delete pruned tracks. Kinematic gating can be applied at 300, for example, to preserve observations that meet one or more predetermined kinematic features. For example, observations yielding potential track updates that fall outside of a gated velocity window (too slow or fast) may be ignored. Surviving observations may undergo feature processing at 305. For example, evidence from a high resolution radar (HRR) may undergo processing to yield a direct classification of an observed target. A measure of track performance can be generated according to technique known as a maximum likelihood estimation at 310. In practice, it is common to work with a logarithm of such an estimation, referred to generally as a “log likelihood.”

In applications providing classification-aided tracking, updated evidence from each sensor observation can be processed, for example, according to the application of evidential reasoning theory to determine a measure of conflict at 315, for example, between a new observation and an existing track. The measure of conflict, when available, can be used in determining a track score update (310). For example, an initial track score in the form of a log likelihood L_{F} can be determined from an updated sensor observation. A refinement by way of a log likelihood track score increment ΔL_{F} can be determined as described above in relation to equation 1. A resulting track score L_{F}′ taking into consideration the benefit of target classification determined through evidential reasoning can be determined at 310 as a combination of the initial track score and the track score increment, e.g., L_{F}′=L_{F}+ΔL_{F}.

For an MHT tracker, an updated hypothesis can be determined at 320 according to each updated track score. For example, a hypothesis can suggest whether an updated sensor observation is related to an existing track. One or more tracks can be filtered and updated at 325 as appropriate according to any hypotheses arrived at. Such updates may include updating an existing track according to the latest updated sensor observation. Updates may also include spawning new tracks, deleting tracks, and splicing or merging multiple tracks into a single track. Tracker applications, such as the multiple hypothesis tracker 225 (FIG. 2) in the examples described herein, generally maintain a stored record of tracks, for example, in the form of a track table. Applications providing classification aided tracking, particularly such applications employing evidential reasoning according to a Dempster-Shafer reasoning theory, maintain a corresponding stored record of tracks. Any filtering in the tracker 225 at 325 that results in removal of one or more tracks, results in a corresponding deletion of pruned tracks at 330 in records maintained by the classification processor 230. Likewise, any updates to existing tracks, including the spawning of new tracks in the tracker 225 at 325, results in a corresponding update and/or spawning of new tracks at 335 in records maintained by the classification processor 230. Processing continues, for example predicting future updates at 340, and repeats for subsequent updated sensor observations. In at least some embodiments, several calculations 337 are carried out by the target classification processor 230.

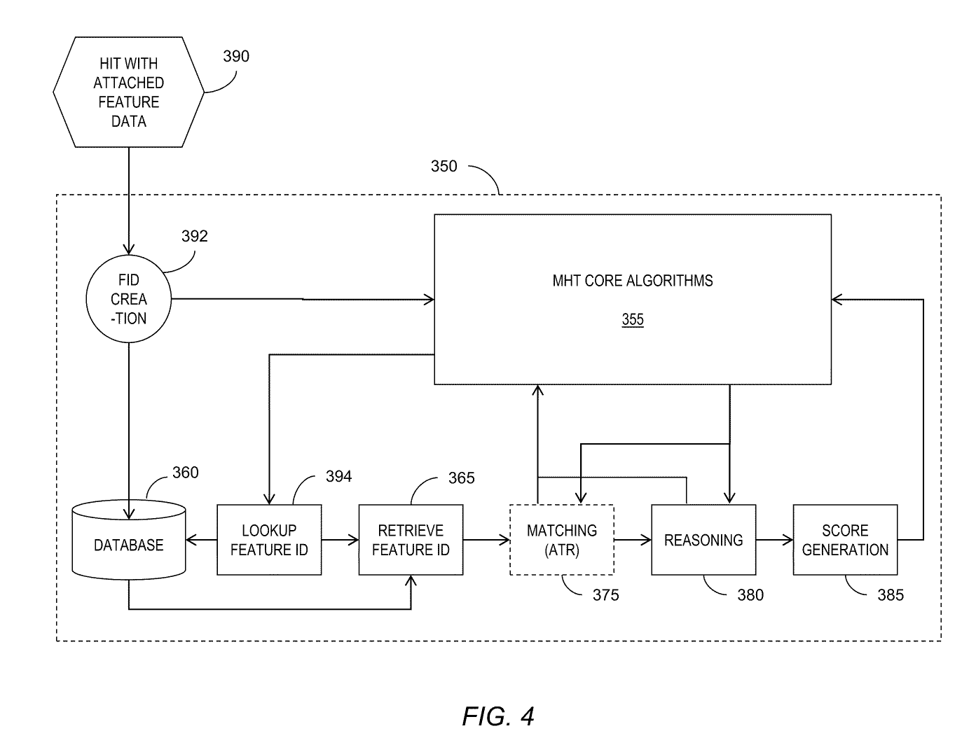

An example functional block diagram of a particular embodiment of an information aggregator employing a classification assisted tracking (CAT) architecture 350 is illustrated in FIG. 4. The CAT architecture 350 includes a core tracking module 355, implementing one or more tracking algorithms, such as algorithms for implementing multiple hypothesis tracking In embodiments including feature recognition, the CAT architecture 350 includes a database 360 for storing indices of one or more features for each observed target. Such features can be used for direct identification or classification of a target. Also included are lookup and retrieval modules 394, 365 for accessing feature identification information from the feature database 360. In some embodiments, the CAT architecture may include an automatic target recognition (ATR) module 375 receiving indicia of feature identification and in response, determining classification of a target. A reasoning engine 380 implementing an evidential reasoning kernel, such as Dempster-Shafer Evidential Reasoning kernel is included for implementing reasoning-based solution to target identification or classification. A score generation module 385 generates a measure of a target's classification, for example, in the form of a score usable to update tracks maintained by the CAT architecture 350.

In operation, an updated observation is received at 390. The updated observation provides evidence 115 (FIG. 1) obtained by one or more sensors 110 (FIG. 1) indicative of an observed object of interest, or target 105 (FIG. 1). In some embodiments, the observed evidence includes indicia of one or more of a target's features. A feature ID module 392 receives the updated observation with attached feature data and creates an updated feature identification. The updated feature information can be stored in the database 360. The evidence is provided to the core tracker module 355 for further processing. In determining an association of the received evidence up with one or more existing tracks, the core tracker module 355 generates a track score. A score above a determined threshold, for example, indicates a proper association allowing maintained track to be updated. When feature data is provided with the updated observation, the core tracker module 355 direct the feature identification lookup module 394 to identify any previously stored feature identification from the feature database 360. For any such feature data available, the feature identification retrieval module 365 retrieves the feature data and forwards it to a matching automatic target recognition module 375, when provided. The reasoning engine 380 may also receive direction from the core tracker module 355 to implement algorithms to process the updated observation evidence and feature data, when provided, to determine a classification of the target. A measure of the target classification is provided to the score generation module 385, which in turn determines an updated score based on the target classification. The updated score is provided to the core tracking module 355 for further processing.

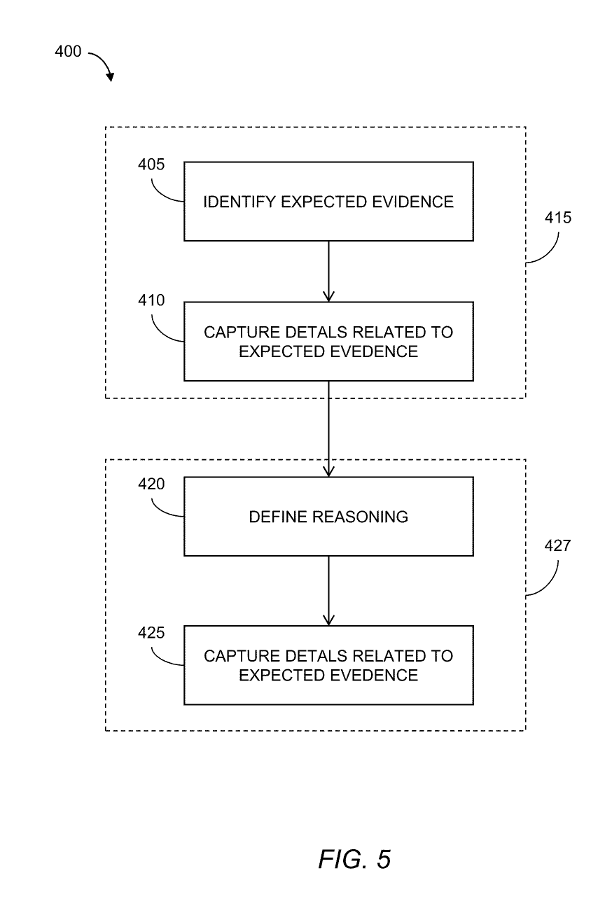

A flowchart detailing an example operation of initialization phase 400 of a particular embodiment of the information aggregator in preparation for aggregating information is illustrated in FIG. 5. During an initialization, a particular problem to which the reasoning is to be applied is analyzed. In the examples described herein, the problem relates to surveillance of ground targets. One or more variables are identified according to the particular problem, along with one ore more expected states for each variable at 405. For example, in a ground surveillance application, variables for association with an observed target may include one or more of: radar cross section; speed; group membership; terrain; and classification type. One or more states for each variable, such as radar cross section and speed ranges, group status, terrain status and expected types of targets are also identified. The results of such initialization can be stored or otherwise captured at 410, for example, in a knowledge base as described herein at 415.

Generally, a knowledge base 275 includes prior knowledge of the particular class of problems, such as information about any information sources (e.g., sensors110). For example, a speed measurement from the tracker system 125 on a target 105 can imply multiple possible target types known to the system. In at least some embodiments, certain treatment of input evidence 115 is also embedded in the knowledge base 275 and carried out in the intermediate data processor 235. For example, information can be discounted based on a priori confidence measures. In at least some embodiments, the above functionality is captured in a file, such as an XML file usable by the data processing module. In some embodiments a description of an XML schema can be captured according to a document type definition (DTD) that specifies the XML syntax. Such a file can be referenced by the data processing module 245 to ensure the knowledge base 275 files adhere to proper XML syntax. Such a knowledge base XML file format specification can identify variable formats, basic frame format for evidence related to the variables, other structures, such as a confusion matrix and/or a conditional probability table, types of expected evidence (e.g., likelihood, one-to-many, declarative, parameter), etc. An example of such an XML file format specification is provided below in Table 1.

TABLE 1
Knowledge Base XML File Format Specification

<!ELEMENT KnowledgeBase (ReasoningNetworkSpecification, Variable+)>
<!ELEMENT ReasoningNetworkSpecification EMPTY>
<!ATTLIST ReasoningNetworkSpecification

| | |
|---|---|
| network | CDATA #REQUIRED |

priorBelief CDATA #REQUIRED>

<!ELEMENT Variable (Frame, (ConfusionMatrix|CPTable|OtmMap)*,
ReliabilityFunction?, ParameterRangeList?,
( DeclarativeEvidence | ParametricEvidence LikelihoodEvidence)*)>
<!ATTLIST Variable

name CDATA #REQUIRED>

<!ELEMENT Frame (Element+)>
<!ELEMENT Element EMPTY>
<!ATTLIST Element

name CDATA #REQUIRED>

<!ELEMENT ConfusionMatrix (Row+)>
<!ATTLIST ConfusionMatrix

| | | |
|---|---|---|
| name | CDATA | #REQUIRED |
| threshold | NMTOKEN | #IMPLIED |
| isLearning | (true\|false) | “false”> |

<!ELEMENT CPTable (Row+)>
<!ATTLIST CPTable

| | | |
|---|---|---|
| name | CDATA | #REQUIRED |

| | | |
|---|---|---|
| truthVariable | CDATA | #IMPLIED |

| | | |
|---|---|---|
| threshold | NMTOKEN | #IMPLIED |
| isLearning | (true\|false) | “false”> |

<!ELEMENT Row (Likelihood+)
<!ATTLIST Row

| truthelement | CDATA #REQUIRED | |
|---|---|---|
| samplesize | NMTOKEN | #IMPLIED> |

<!ELEMENT Likelihood (#PCDATA)>
<!ATTLIST Likelihood

| | |
|---|---|
| declaredelement | CDATA #REQUIRED> |

<!ELEMENT OtmMap (DeclaredElement+)>
<!ATTLIST OtmMap

| | | |
|---|---|---|
| name | CDATA | #REQUIRED |

| | | |
|---|---|---|
| outputVariable | CDATA | #REQUIRED> |

<!ELEMENT DeclaredElement (#PCDATA)>
<!ATTLIST DeclaredElement

| | | |
|---|---|---|
| state | CDATA | #REQUIRED> |

<!ELEMENT ParameterRangeList (Range+)>
<!ATTLIST ParameterRangeList

name CDATA #REQUIRED>

<!ELEMENT Range EMPTY>
<!ATTLIST Range

| | | |
|---|---|---|
| element | CDATA | #REQUIRED |
| low | NMTOKEN | #REQUIRED |
| high | NMTOKEN | #REQUIRED> |

<!ELEMENT ReliabilityFunction (Reliability+)>
<!ELEMENT Reliability (#PCDATA)>
<!ATTLIST Reliability

| | | |
|---|---|---|
| probability | NMTOKEN | #REQUIRED> |

<!ELEMENT DeclarativeEvidence ( BPAConstruction ) >
<!ATTLIST DeclarativeEvidence

| source CDATA #REQUIRED | | |
|---|---|---|
| destinationName | CDATA | #IMPLIED |
| confusionmatrix | CDATA | #IMPLIED |
| otmmap | CDATA | #IMPLIED |
| isSetAllowed | (true\|false) | “false” |

| | | |
|---|---|---|
| isDiscountedByConfidence | (true\|false) | “false” |

| | | |
|---|---|---|
| noConfidenceDefault | CDATA | “−9999.0”> |

<!ELEMENT ParametricEvidence (BPAConstruction)>
<!ATTLIST ParametricEvidence

| | | |
|---|---|---|
| source | CDATA | #REQUIRED |

| | | |
|---|---|---|
| destinationName | CDATA | #IMPLIED |
| error | NMTOKEN | #IMPLIED |
| ranges | CDATA | #IMPLIED> |

<!ELEMENT LikelihoodEvidence (BPAConstruction)>
<!ATTLIST LikelihoodEvidence

| source CDATA #REQUIRED | | |
|---|---|---|
| destinationName | CDATA | #IMPLIED |

| | | |
|---|---|---|
| isDiscountedByConfidence | (true\|false) | “false” |

| | | |
|---|---|---|
| noConfidenceDefault | CDATA | “−9999.0”> |

<!ELEMENT BPAConstruction EMPTY>
<!ATTLIST BPAConstruction

| | | |
|---|---|---|
| ratio | NMTOKEN | #IMPLIED |

| | |
|---|---|
| algorithm | (SIMPLE_SUPPORT \| CONSONANT_BELIEF) #IMPLIED |

| | | |
|---|---|---|
| isDiscountedByLikelihood | (true\|false) | “false”> |

Likewise, relationships between two or more of the identified variables can be identified and used to determine a methodology for reasoning solutions for the problem at 420 (e.g., identification of target type in the ground surveillance scenario). Such reasoning methodology can be stored or otherwise captured at 425, for example, in a fusion network, or join tree as described herein, the process collectively initializing a fusion network at 427.

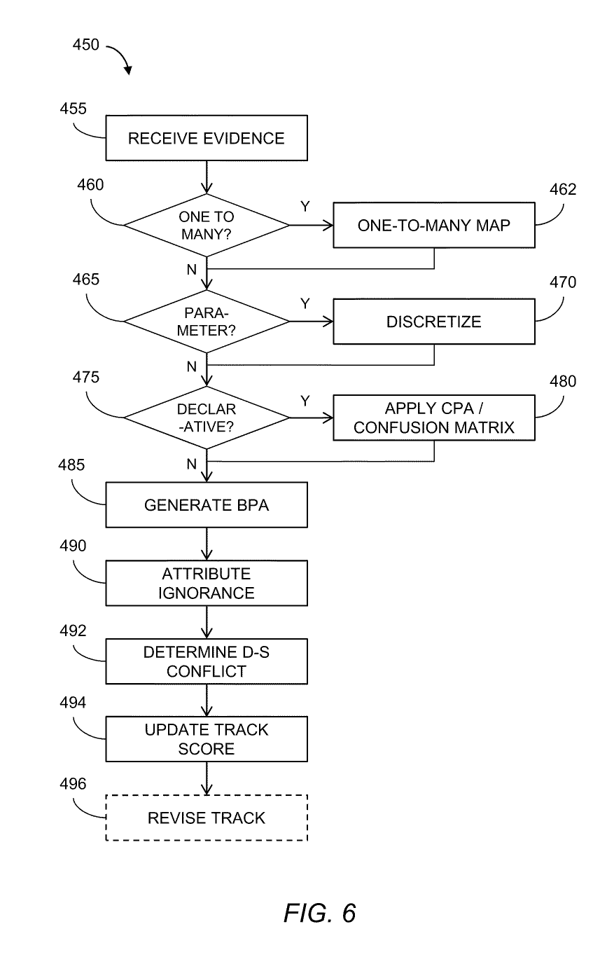

A flowchart detailing an example operation of a particular embodiment of the information aggregator in aggregating information is illustrated in FIG. 6. An embodiment of an information aggregation process 450 receives from one or more sensors 110 (FIG, 1) updated evidence 115 (FIG. 1) at 455 indicative of an object of interest 105 (FIG. 1). The evidence 115 corresponds to system variables previously identified in an initialization phase 400 (FIG. 5). Accordingly, the evidence can be one of a variety of types of evidence. In the example embodiment, the type of evidence may be simply declarative (e.g., the target is a member of a group), parametric (e.g., evidence taking on values in a continuous range: speed; radar cross section), or a type requiring a mapping to another variable, referred to herein as a one-to-many map.

If it is determined that the type of evidence is one-to-many at 460, then a suitable mapping of the evidence to another representative variable is performed at 462. If it is determined that the type of evidence is parametric at 465, then the evidence is discretized at 470. For example, numeric evidence of a target's radar cross section may fall anywhere within a range of values. The range can be divided into a number of non-overlapping sub ranges that span the entire range (e.g., small, medium, large, and extra large). The state of the variable is transformed from a continuous RCS value, to a discretized RCS value. Similarly, if it is determined that the type of evidence is declarative at 475, then a predetermined likelihood can be applied at 480.

Having organized the received evidence into appropriate variables and their associated states, a basic probability assignment (BPA) is performed at 485. The basic probability assignments may be classical probabilities specified by their mass function, also referred to as a belief function. A nonzero mass indicative of ignorance is attributed to the BPA at 490. A Dempster-Shafer conflict is determined at 492. In at least some instances, the conflict can be determined between a BPA associated with the latest received evidence and a previously determined BPA. A track score is updated at 494 in response to the conflict, and track is revised as necessary at 496 (e.g., updated, deleted).

Referring again to FIG. 2, the information aggregator 220 maintains at least one retrievable record, such as a database 296, in which the information aggregator 220 stores information pertaining to one or more objects of interest 105 (FIG. 1). In particular embodiments, the target classification processor 230 stores in the database 296 information indicating a degree of belief that particular variables relating to a monitored object of interest 110 have particular states. More specifically, the target classification processor 230 stores information indicating that a particular configuration accurately reflects the state of a particular subset of variables, or “frame,” associated with that configuration. This degree of belief may be represented by a basic probability assignment (“BPA”), belief mass, belief value, disbelief value, plausibility value, confidence level, trust level, and/or other any other appropriate measure of belief, trust, or confidence (all of which are referred to generically herein as a “valuation”).

As noted above, evidence 115 provides support for a particular configuration, and information aggregator 120 generates a valuation to associate with that particular configuration, based on received evidence 115, in any appropriate manner. As one example, in particular embodiments, sensors 110 may provide confidence levels as part of evidence 115 that reflect confidence the relevant sensors 110 have in measurements captured by the generated evidence 115. In such embodiments, sensors 110 may determine confidence level based on the environmental conditions under which the measurements were taken, the type of measurements being made, or other suitable factors. As another example, information aggregator 120 may store reliability scores for sensors 110 indicating the reliability of evidence 115 provided by sensors 110 and may generate valuations based on these reliability scores. More generally, however, information aggregator 120 can generate the valuations in any suitable manner based on received evidence 115 and/or other available information.

As the information aggregator 120 receives evidence, it processes the newly-received evidence 115 to allow the information aggregator 120 to effectively combine the new evidence 115 with previously-received evidence 115. Such processing may involve the application of one or more weightings to the received evidence 115 (e.g., based on confidence levels associated with the received evidence 115), quality-checking of the received evidence 115, extracting data from the received evidence 115, and/or otherwise processing the received evidence 115. The information aggregator 120 then aggregates newly-received evidence 115 with existing evidence 115 and correlates this to a priori information regarding objects of interest 105 in the database 296. In particular embodiments, the information aggregator 120 utilizes evidential reasoning techniques to aggregate evidence 115 and then make determinations based on the aggregated evidence 115.

For example, in the illustrated embodiment, the information aggregator 220 implements Dempster-Shafer information-fusion algorithms to aggregate evidence 115 and draw inferences from the aggregated evidence 115. As part of implementing these algorithms, the information aggregator 220 can maintain a belief network that indicates relationships between valuations and other data associated with the variables monitored by system 100 (FIG. 1). In the illustrated embodiment, the information aggregator 220 models this belief network with a join tree 280 stored as a series of data objects. Each of these data objects represents a node 298 in join tree 280 and includes pointers to objects modeling neighboring nodes 298 in the join tree 280. The join tree 280 can be generated in a similar manner to that described in “Binary Join Trees for Computing Marginals in the Shenoy-Shafer Architecture,” International Journal of Approximate Reasoning, 17(2-3), 1997, 239-263, which is incorporated herein by reference.

In an example, the information aggregator 220 updates the join tree 280 based on newly-received evidence 115 by combining evidence 115 with existing information in the join tree 280. For example, if the evidence 115 indicates a particular BPA (BPA₁) for a first frame (A), the information aggregator 220 may add this evidence 115 to the join tree 280 by combining BPA₁ with the information stored in an existing node 298 of the join tree 280. Assuming the existing node 298 of the join tree 280 stores a BPA (BPA₂) for a second frame (B), the new evidence 115 can be combined with the information stored in the existing node 298 to form a combined BPA (BPA₁₂) over a new frame (C) in accordance with Dempster's Rule of Combination. For example, the first frame may relate to a current observation; whereas, the second frame may relate to a previously stored track. Based on Dempster's Rule of Combination, the combined BPA can be calculated as:

$$\begin{matrix} {BPA}_{12} ( C ) = \frac{\text{?} {BPA}_{1} ( A ) {BPA}_{2} ( B )}{1 - k} & Eq . 3 \\ k = \text{?} {BPA}_{1} ( A ) {BPA}_{2} ( B ) & Eq . 4 \\ \text{?} \text{indicates text missing or illegible when filed} & \end{matrix}$$

As the above equations suggest, combining new evidence 115 with existing information in the join tree 280 involves determining the intersection of several different elements of the combined sets. Each element of the combined sets (i.e., A and B) may provide information regarding a large number of different propositions. The term “k” measures the extent of conflict between the different frames. This value directly reflects how much the two different frames are in conflict with each other. In at least some embodiments, combination of evidence using the join tree 280 can be implemented in a similar manner to that described in U.S. patent application Ser. No. 12/713,331, entitled “System and Method for Aggregating Information,” filed on Feb. 26, 2010, which is also incorporated herein by reference in its entirety.

As evidence 115 is added to database 296, the amount of information supporting the various variable states, and thus, the various propositions monitored by system 100 increase. As the information supporting these propositions increases, the information aggregator 220 may determine that sufficient evidence 115 has been collected to make a determination relating to the monitored objects of interest 110. For example, in the illustrated Dempster-Shafer embodiment, the information aggregator 220 may determine after inserting one or more sets of evidence 115 that the valuations stored in join tree 280 indicate a level of support for a specific collection of propositions that exceeds a predetermined threshold. Based on this collection of propositions, the information aggregator 220 may determine a type classification of the objects of interest 105. For example, in a particular instance, the information aggregator 220 can determine that the support for the propositions associated with a small radar cross section (RCS), slow speed, off-road and in-group exceed predetermined thresholds and select a type corresponding to this collection of characteristics, e.g., a howitzer.

The information aggregator 220 can then communicate this determination to a client application, such as the track processor 225, and ultimately to a user of the system 100 (FIG. 1). The information aggregator 220 can also store the determination for subsequent use, instruct other components of the system 100 to initiate certain actions based on this determination, and/or take any other appropriate steps based on the determination. As one example, the information aggregator 220 may incorporate or interface with a monitor, light emitting diodes (LED) display, printer, or other suitable output components and may be capable of displaying the determination, generating reports analyzing the determination, or otherwise communicating information pertaining to the determination to users. As another example, the information aggregator 220 may incorporate or interface with some form of electronic memory, such as a local hard drive, a network-attached storage (NAS) system, a storage area network (SAN), or other appropriate types of memory components and may be able to store the determination for subsequent analysis. More generally, however, the information aggregator 220 may be configured to take any appropriate action or utilize the determination in any suitable manner.

For example, in the illustrated embodiment, the information aggregator 220 couples to a computer monitor that displays the position of nearby objects of interest 105 on a graphical map. After determining the type of a particular object of interest 105, the information aggregator 220 may display text indicating the determined type on the map next to an icon representing the position of the relevant object of interest 105. A user of the system 100 may then be able to use this data to make informed decisions targeting objects of interest se in a weapons-type scenario and reduce the likelihood of targeting friendly units.

Because the sensors 110 (FIG. 1) may collect data continuously or at very rapid increments, the amount of evidence 115 received and processed by the information aggregator 220 can be substantial. Furthermore, in particular embodiments, such as the combat scenario described above, the information aggregator 220 may need to make determinations on evidence 115 quickly. By efficiently identifying and ordering the configurations associated with nodes 298 of the join tree 280 and/or newly-received evidence 115, particular embodiments of the information aggregator 220 may reduce the time and resources utilized to aggregate evidence 115, as described further below with respect to FIGS. 3-9. As a result, particular embodiments of system 100 may provide several operational benefits. Specific embodiments, however, may provide some, none, or all of these benefits.

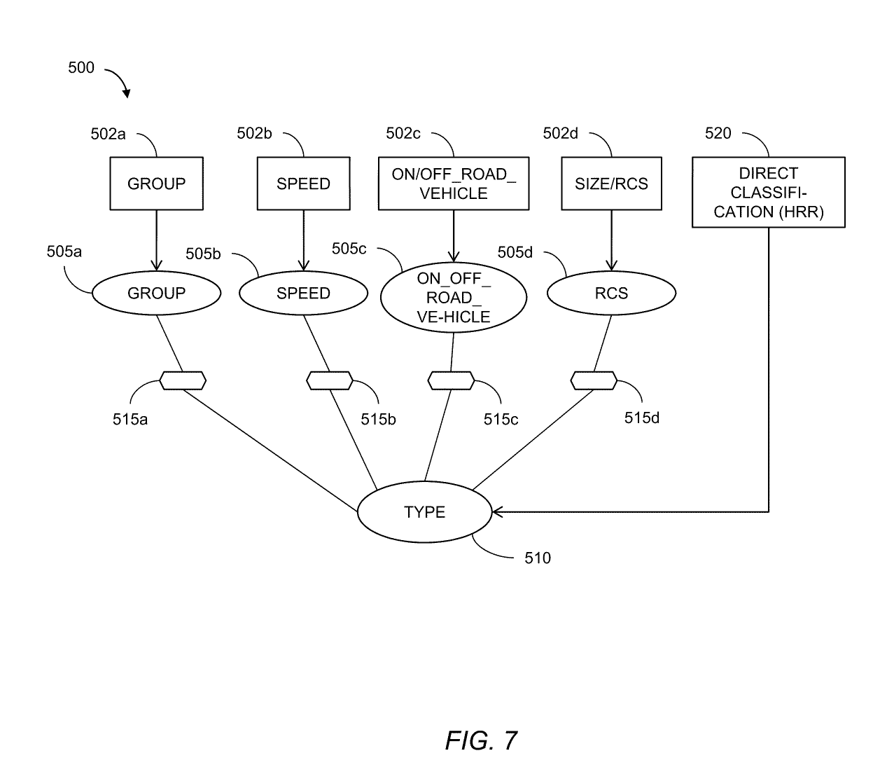

A graphical representation of a particular embodiment of a fusion network 500 is illustrated in FIG. 7. In particular, an internal data structures, such as ordered lists, can be created within the data fusion processor 240 (FIG. 2) to facilitate processing. In this example, four oval nodes are provided representing variables associated with expected evidence to be received from the sensors 110 (FIG. 1) and/or tracker 225 (FIG. 2): group 505a; speed 505b, on-off road vehicle 505c; and radar cross section 505d (generally variable nodes 505). The evidence itself related to each respective node is provided in a rectangle graphically connected to each variable node 505. For the example target classification problem, each variable node 505 is connected to a common variable node 510, representative of a resultant characteristic “type” of target. Optionally, an intermediate hexagonal node 515a, 515b, 515c, 515d (generally 515) is respectively positioned between each variable node and the type node 510. The hexagonal nodes are indicative of a relationship between the respective variable node 505 and the resultant type node 510, referred to as relationship nodes 515: group-type relationship 515a; speed-type relationship 515b; on-off_road_vehicle-type relationship 515c; and RCS-type relationship 515d. In some embodiments, additional evidence can be related directly to the type node 510. For example, direct classification evidence 520 received from a high-resolution radar is graphically illustrated by a rectangular node 520 connected directly to the type node 510.

Once created, such data structures can be used to facilitate the combination of information from the example group node 505a with information from other nodes 505b, 505c, 505d and/or evidence generally 502. By storing the various configuration identifiers associated with a particular variable node 505 of the join tree 500 in ordered lists, the information aggregator 220 (FIG. 2) may simplify the task of updating the join tree 500 based on evidence (e.g., group evidence 502a; speed evidence 502b; on/off-road vehicle evidence 502c; and size/RCS evidence 502d—generally evidence 502), and direct evidence 520 or aggregating data in the join tree 500 to make determinations. Under a technique generally known as Shafer's Rule of Combination, aggregating evidence stored in the join tree 500 to determine a belief value for a particular state or updating the join tree 500 based on new evidence 502 involves determining the effect of the valuations for which a particular variable node 505 holds evidence 502 on the valuations stored by every other node 505 in the join tree 500. This may involve calculating the intersection of every configuration for which a particular node 505 stores information with every configuration of newly-added evidence 502 and propagating the results through the join tree 500. Alternatively, in particular embodiments, the information aggregator 220 may be configured to utilize “lazy propagation.” In such embodiments, instead of immediately propagating changes through the join tree 500, the information aggregator 220 may invalidate network caches to force propagation if and when affected data in the join tree 500 is needed. Regardless of when propagation occurs, storing configuration identifiers in an ordered list simplifies the process of comparing the configurations of example node 505a with those of other nodes 505b, 505c, 505d and determining what elements are shared by the configurations.

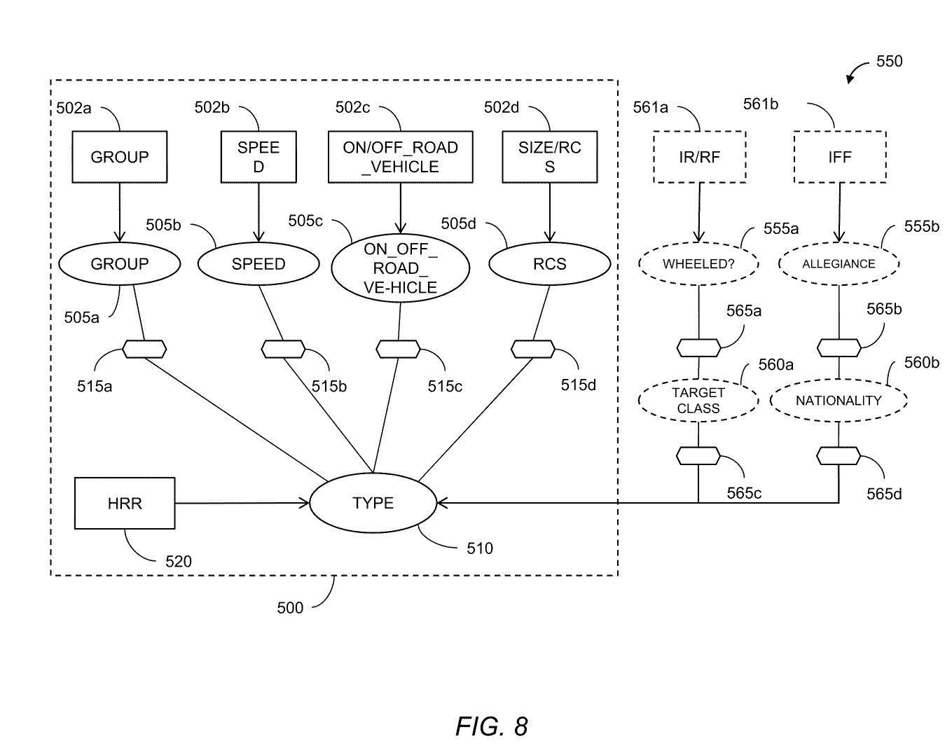

A graphical representation of an alternative embodiment of a more complex fusion network, or join tree 550 is illustrated in FIG. 8. The join tree includes the same join tree 500 in FIG. 4, with additional nodes illustrating fusion involving multiple levels of target type/class taxonomies (i.e., including type 555a, class 560a, nationality 560b, and allegiance 555b), and target features feeding to any level of the taxonomy. The example shown in FIG. 7 only contains a single level of taxonomy (i.e., target type). FIG. 8 shows an example of a possible fusion network 550 that extends the baseline network shown in FIG. 7 to include additional (IR/RF) features 561a for wheeled versus tracked vehicles and identification-friend-or-foe (IFF) features 561b for allegiance 555b, and additional taxonomy levels (target class 560a and nationality 560b) above target type 510 in the baseline network 500. Respective relationship nodes 565a, 565b, 565c, 565d can be included between one or more pair of nodes.

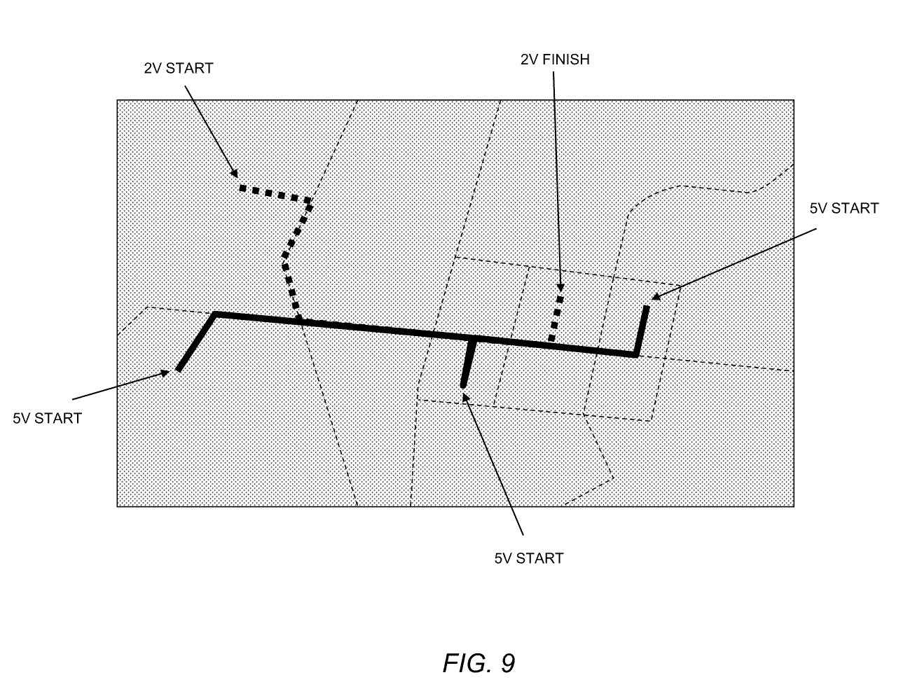

FIG. 9 illustrates tracking results of an example scenario observed by an intelligence-gathering system 100 (FIG. 1). The example scenario contains two ground vehicle convoys, one consisting of five vehicles (5V) while the other containing two vehicles (2V). The targets 5V, 2V travel in groups in close proximity and therefore the tracks are difficult to maintain without classification aided tracking or feature-aided tracking in general. The input to the tracker 225 (FIG. 2) is a set of simulated ground-moving-target-indicator measurements from two airborne sensor platforms 110 (FIG. 1). At each measurement, a high-resolution radar (HRR) signature based on sensor data may also be available. However not all ground-moving-target-indicator data points have associated high-resolution-radar signatures. In this example, the entire scenario contains about 1,400 seconds of simulation with more than 4,000 frames of target measurements and random clutters.

In an illustrative example, prior knowledge for a data set is shown in Table 2A through Table 4. The information in Tables 2A, 2B and Table 4 is encoded in the knowledge base file 275, while the information in Table 3 (with the exception of On_Off_Road column) is represented in the fusion network 280.

In this example, five discrete variables are identified during an initialization phase for a ground surveillance scenario: (i) Type={suv truck gun wheeled_apc tracked_apc howitzer scout_veh}; (ii) Speed={slow moderate fast}; (iii) RCS ={small medium large xlarge}; (iv) Group={ingroup notingroup}; and (v) On_Off_Road={On Off}. Corresponding states of each of the variables also determined during the initialization phase are identified in brackets.

A tracker 225 provides target ID evidence 115 in both parametric feature measurements (e.g., Speed and RCS), and declarations (e.g., Group and On_Off_Road). For declarative evidence (Group and On_Off_Road), a simple support function can be constructed in the intermediate data processor 235. For parametric evidence (e.g., Speed and RCS), the information shown is represented in the knowledge base 275 and used to map the input parameter measurements into single discrete state (this is possible, since the ranges do not overlap), then to a simple support function. In both cases, the initial mass assigned to a simple support function is 1.0, which is subsequently reduced by a discounting factor. In the case of declarative evidence (e.g., Group and On_Off_Road), confidence values provided by the tracker 225 can be used as the initial simple support mass.

Beneficially, the intermediate data processor 235 allows the performance of a declarative type evidence source to be quantified. This can be accomplished through one or more of a data structure known as a confusion matrix and another data structure known as a conditional-probability table. Either of these features would be provided in the knowledge base 275 and available for interpretation and/or processing of declarative type evidence. At least one advantage of a conditional-probability table over a confusion matrix is that the conditional-probability table does not need to be square, nor do the truth and the declared discrete states have to be from the same variable. Thus, with the conditional-probability table, such restrictions on confusion matrix are avoidable. In operation, one piece of declarative evidence can be used to induce identification evidence based on the given conditional-probability table stored in the knowledge base 275.

In the illustrative example, the tracker 225 also processes high-resolution radar (HRR) measurements against an HRR feature database 360 (FIG. 4), for example, using correlation methods such as those described in “Joint IMM/MHT Tracking and Identification with Application to Ground Tracking,” Signal and Data Processing of Small Targets 2005, by J. Lancaster, S. Blackman, and E. Taniguchi, edited by Oliver E. Drummond, Proc. Of SPIE Vol. 5913, 59131 H, (2005), incorporated herein by reference in its entirety. The tracker 225 also provides likelihood values on the variable “Type.” Accordingly, the high-resolution radar provides direct target type evidence as opposed to indirect evidence provided by other features. This is modeled in FIG. 7 by a direct connection between the direct classification (HRR) evidence 520 and they Type variable 510.

TABLE 2A
Feature parameters to discrete category mapping
for target RCS and Speed categories.

| RCS categories | RCS |
|---|---|
| small | <175.0 |
| medium | 175.0~<250.0 |
| large | 250.0~<350.0 |
| xlarge | >=350.0 |

TABLE 2B
Feature parameters to discrete category mapping
for target RCS and Speed categories.

| Speed categories | Speed |
|---|---|
| slow | <15.0 |
| moderate | 15.0~<30.0 |
| fast | >=30.0 |

Target characterization, or ID feature related information provided by the tracker 225 is not perfect. Therefore each mass function produced by the target feature is reformatted to ensure a minimal mass of 0.1 on ignorance frame. This is equivalent to discounting a mass function by a factor of α=0.9.

In a similar approach employed in the data fusion processor 240, the same type of operation is performed expressing a confidence in the information represented in each piece of evidence 115. Thus, for a confidence of 90% in what a piece of evidence 115 is saying, 0.9 is used as a discount factor to discount the mass function constructed by the intermediate data processor 235.

Rather than expressing this confidence (or discount factor) directly, in the knowledge base 275, a constant ratio ‘r’ can be assigned in the knowledge base 275 to every type of input evidence. This ratio is similar to a likelihood ratio, falling between 1 and positive infinity. The higher the ratio, the greater the confidence in the evidence. A simple relation between ratio r and the discounting factor α is:

α=1−1/r Eq. 5

Using a ratio r instead of confidence results in a “linear” scale, and represents the ratio between the likelihood that the evidence is true versus the complement (or the opposite) is true.

Thus, a ratio of 10 for an input feature is equivalent to a discounting factor of 0.9, providing for a minimal ignorance mass of 0.1. Similarly, a ratio of 2 provides for a minimal ignorance mass of 0.5.

As discussed above, part of prior knowledge for classification assisted tracking using data fusion is represented in the “fusion network” file 280 in the data fusion processor 240. In at least some embodiments, the fusion network file 280 is also written in XML, defining the system variables and their states, the relationship between the variables and any mass functions defined on the variable nodes or relation nodes. The fusion network file 280 describes a graph of the fusion reasoning problem at hand as illustrated in FIG. 7, and quantifies the nodes with respective belief mass functions. The data fusion processor 240 uses this information to form internal data structures necessary for the representation and combination/fusion of the belief functions.

TABLE 3
Target Type to target feature mapping table.

| Type# | Type name | RCS | Speed | On_Off_Road | Group |
|---|---|---|---|---|---|
| 1 | suv | medium | fast | on | noingroup |
| 2 | howitzer | small | slow | off | ingroup |
| 3 | wheeled_apc | xlarge | mod- | on, off | ingroup |
| | | | erate | | |
| 4 | tracked_apc | large | slow | off | ingroup |
| 5 | truck | medium | mod- | on | noingroup |
| | | | erate | | |
| 6 | gun | small | slow | on, off | ingroup |
| 7 | scout_veh | medium | mod- | on, off | ingroup |
| | | | erate | | |

For the present example, the initial design of the network is simple (see FIG. 7). The structure of the network is dictated by the problem, and the design issue relates to how the mass functions are filled in for each of the relation and the variable nodes 510, 505. In the present example, there is no mass function assigned directly to the variable nodes 505 (this could represent prior distribution, e.g.), but only on relations 515. The mass functions on relation nodes 515 represent the mapping between variables 505 connected by the relation node. For example, the relation between Type 510 and RCS 505d matches the information shown in Table 3. This can be accomplished by using a so-called “logical” mass function, a mass function having only one focal set bearing all the mass (1.0).

Thus, a mapping between Type 510 and Group 505d (group represents the notion that military vehicles tend to move in groups) translates to the following logical mass function: m(A)=1.0, in which A={(suv noingroup) (truck notingroup) (howitzer ingroup) (wheeled_apc ingroup) (tracked_apc ingroup) (gun ingroup) (scout_veh ingroup)}. However, the group information is not very precise since even for vehicles that “tend” to travel in groups, they will travel alone occasionally, and for vehicles not usually associated with a group, they can also accidentally travel in a group. Therefore a large discounting value can be used to the above relationship to represent the uncertain nature of the mapping.

Table 4 provides a target Type 510 to target feature mapping the variables: TCS; Speed; On_Off_Road; and Group. The relation between Type and RCS and that between Type and Speed can be represented in the same way as in Group.

TABLE 4
Target Type and OnOffRoadVehicle mapping

| Type | OnOffRoadVehicle |
|---|---|
| suv | onroad |
| howitzer | offroad |
| wheeled_apc | onandoffroad |
| tracked_apc | offroad |
| truck | onroad |
| gun | onandoffroad |
| scout_veh | onandoffroad |

The mapping between Type 510 and On_Off_Road is a little different. The information whether a vehicle is on- or off-road is useful because it puts restriction on the possible types the vehicle can be when we observe the vehicle being on- or off-road. For example, a truck is considered on-road vehicle, therefore truck is considered as a possible vehicle type when a target is see traveling on road. Likewise, the same goes for off-road vehicles. However, some vehicles can travel both on- and off-road, e.g., a wheeled_apc. That means “on” and “off” road are not exclusive behaviors for certain vehicles (in D-S reasoning all discrete states of a variable must be exclusive and collectively comprehensive. This also applies to Bayesian reasoning.)

It is apparent that there are actually three possible vehicle types in this case, those that can travel only on-road, those that can travel only off-road, and those that can travel both on- and off-road. Thus, all three states are represented and accordingly handled by their mapping with Type. At the same time, the reported on- and off-road information are interpreted slightly different. When the tracker 225 reports on-road, it implies on- and off-road. When it reports off-road, it also implies on- and off-road.

A 3-state vehicle type variable is provided as solution to this problem, such that the intermediate processor 235 interprets and translates the input feature “on” or “off” road into the possible vehicle type accordingly: OnOffRoadVehicle={onroad, offroad, onandoffroad}. Beneficially, the intermediate data processor 235 provides for structures supporting a one-to-many map. Such a structure can be stored in the knowledge base 275 and is available to handle “equivalence class” type of evidence transformation for declarative identification evidence. For example, the declaration of “wheeled_vehicle” can be mapped to a whole class of vehicles with wheels. While this mapping can also be carried out through the fusion network 280, it is more efficiently implemented inside the intermediate data processor 235.

After the mapping, as shown in Table 4, each vehicle type is mapped to a unique OnOffRoadVehicle type. A one-to-many map is defined in the knowledge base 275 during the initialization phase to interpret the on/off road information and transform it into evidence on OnOffRoadVehicle:

On_Off_Road=on: {onroad, onandoffroad}

On_Off_Road=off: {offroad, onandoffroad}

That is when On_Off_Road indicates “on”, the OtmMap will output “{onroad, onoffroad},” and On_Off_Road indicates “off,” the OtmMap will output “{offroad, onoffroad}.” The resulting sets from OtmMap are then properly formatted into mass functions using simple support function as ID evidence to be sent to the Dempster-Shafer kernel for combination. The example fusion network 500 illustrated in FIG. 7 reflects a revision having replace the variable On/Off-Road by the variable OnOffRoadVehicle 505c, with a mapping between the new variable and Type as shown in Table 4.

In at least some embodiments, the systems and processes described herein are implemented in real-time applications. As such, potentially large volumes of information must be processed in relatively short periods of time (e.g., between successive sensor update reports). At least one approach to facilitate processing speed is division of processing tasks among the various system components. Accordingly, respective portions of the target classification processing can be performed among two or more of the sensors 110 themselves, the track processor 225, the intermediate data processor 235, and the data fusion processor 240. For example, as described herein, the intermediate data processor 235 can maintain a knowledge base 275 and prepare basic probability assignments for forwarding to the data fusion processor 240 for further processing. The data fusion processor 240 can determine a conflict as a measure of association between the latest observation and an existing (i.e., previously stored) track and/or between different existing tracks. The conflict term can be returned to the intermediate data processor 235 or to the track processor 225 for calculation of a track score update as also described herein.

In some aspects, the intermediate data processor 235 also acts as an input/output (I/O) unit for the data fusion processor 240. For example, the ingest module interprets input evidence and formats a mass function for reasoning by the data fusion module 260. An application programming interface (API) is provided 292 in the intermediate data processor 235 to facilitate communications between an application, such as the tracker 225, and the data fusion processor 240. Examples of some functions that may be supported by such an API 292 are provided in Table 5.

TABLE 5
Summary of Intermediate Data Processor API functions.

| API functions | Description |
|---|---|
| Init | Start and initialize the ID fusion engine |
| Close | Shutdown the ID fusion engine and |
| | release resources |
| AddTrack | Add a track to ID fusion engine, |
| | optionally with new evidence |
| DeleteTrack | Remove a track from the ID fusion |
| | engine |
| SpawnTrack | Spawn a new track from an existing one |
| Evidence | Add new evidence to an existing track |
| Query | Get the up-to-date ID states (pignistic |
| | probabilities) for a set of pre-defined |
| | variables |
| QueryVar | Get the up-to-date ID state (pignistic |
| | probability) for a given variable |
| Conflict | Compute and return the conflict between |
| | a given piece of ID evidence and the |
| | belief state for a given variable in ID |
| | engine |
| ConflictTrack | Compute and return the conflict between |
| | the believe states of two tracks on a |
| | given variable in ID engine |
| MergeTracks | Merge two or more existing tracks to |
| | create a new track with all the ID |
| | evidence pooled together |
| MergeTrackslnto | Same as cidMergeTracks, but the target |
| | track should already exist and its ID |
| | evidence is also pooled together |
| DeleteQueryResultList | Release memory occupied by the |
| | returned results from cidQuery( ) and |
| | cidQueryVar( ). |
| GetLastErrorMsg | Receive a read-only string containing the |
| | error message after an API call fails |
| | (returning non-zero values) |

In particular, a function “ConflictTrack” called by the tracker 225 computes conflicts between two existing tracks in the data fusion processor 240. Functions “MergeTracks” and “MergeTracksInto” both merge existing tracks in the data fusion processor 240, with the former creating a new track for the merged track, and the latter merging the tracks into an existing track. These functions can help perform track splicing in association with a multiple hypothesis track processor 225. Other functions, such as “GetLastErrorMsg,” can be used in debugging and error reporting. Thus, whenever an error occurs (e.g., during an API function call), such a function can be called to retrieve a read-only string indicating the exact circumstance and reason for the condition, which is more specific than the error code alone can provide. Also, a function “Conflict” returns an ignorance mass of both the track and the input evidence, which is required by Eq. 1 for computing the association score increment.

Examples of syntax for socket commands between the intermediate date processor 235 and the data fusion processor 240 that usable with a TCP/IP socket stream are described below. The following commands represent samples of such commends. Namely, the example commands are: n_ATOMIC_CONFLICT (see Table 6); ATOMIC_CONFLICT_REPLY (see Table 7); ATOMIC_CONFLICT_ERROR; and n_ATOMIC_CONFLICT2 (see Table 8).

TABLE 6
Example Conflict Command Between New
Observation and Existing Track

n_ATOMIC_CONFLICT <graph name> <user data> getvaluations
<bpa>;
<graph name> = the name of the graph to query. The evidence is not
accumulated, therefore, the queried graph inside the Kernel is not affected
and stays the same after this command ends and the Kernel has produced
the requested output.
<user data> = any string data enclosed in double quotes or the token
NULL
getvaluations = the token required to perform the conflict calculation
< bpa > = <variable name A> <focalset count N>

<member count N₁ for focalset A₁> <focalset member A₁₁> ...
<focalset member A_{1N1}> <mass for focalset A₁>

...

<member count N_{N} for focalset A_{N}> <focalset member A_{N1}> ...
<focalset member A_{1NN}> <mass for focalset A_{N}>

This basic conflict command sends evidence of a basic probability assessment for an observed variable to the data fusion processor 240 (FIG. 2). It combines this new evidence and the corresponding marginal previously stored in the belief network 280 (FIG. 2), according to a process known as Dempster's Rule of Combination, and returns a corresponding conflict value, k. It is not necessary for the data fusion processor 240 to make any changes to the belief network 280 as a result of this command. The field <graph name> identifies a graph previously created, for example with a suitable command creating a new graph or merging existing graphs. The field <user data> can be anything that the calling application specifies to identify this particular request, such as a string enclosed in double quotes. The same string is will appear in a reply message (see below) from the fusion processor 240 as a reply to this command.

By way of example, a TCP socket for a basic conflict command is represented by: n_ATOMIC_CONFLICT trackl “mydata” getvaluations T 3 1 T1 0.1 2 T1 T2 0.2 3 T1 T2 T3 0.4. The command is interpreted as follows. First, the current graph is set to “track1” and “mydata” is returned as user data. Next valuations for the variable “T” are combined as follows: 3 valuations for variable T: (i) 1 member in set {T1} with mass=0.1; (ii) 2 members in set {T1 T2} with mass=0.2; and (iii) 3 members in set {T1 T2 T3} with mass=0.4. By default, the left-over mass 1−(0.1+0.2+0.4)=0.3 is assigned to the vacuous configuration/set.

After receiving a conflict command or call, the data fusion processor 240 generates and replies, for example, with an ATOMIC_CONFLICT_REPLY or ATOMIC_CONFLICT_ERROR message. The conflict reply message is generated in response to a successful conflict request command (e.g., n_ATOMIC_CONFLICT). An example structure of a conflict reply is provided in Table 7. The field <user data> can be enclosed with double quotes and is preferably identical to the <user data> parameter of the original n_ATOMIC_CONFLICT command sent to the data fusion processor 240. The field <conflict> can be represented as 1's compliment to allow representation of high conflict conditions in printed text form more accurately when the conflict value is close to 1.0. An error message would be generated by the data fusion processor 240 for situations in which a conflict command cannot be executed for any of various reasons (e.g., graph or variable not found).

TABLE 7
Example Conflict Reply Command

ATOMIC_CONFLICT_REPLY <user data> <graph name> <set
values>;

(This is not a command, but rather the format for the reply message

from the Kernel in response to an n_ATOMIC_CONFLICT command).
<user data> = any string data enclosed in double quotes or the token
NULL, same as the <user data> in the original n_ATOMIC_ CONFLICT
command.
<graph name> = the name of the graph to update or query
<set values> = setvalues <variable name > <conflict > <ignorance
mass1> <ignorance mass2>
<variable name > = name of the variable
<conflict> = 1.0 − <actual conflict>
<ignorance mass1> = mass assigned to the vacuous configuration for the
variable associated with <variable name> of the graph <graph name>
<ignorance mass2> = the mass assigned to the input BPA in the
n_ATOMIC_CONFLICT command. It is useful for the
n_ATOMIC_CONFLICT2 command described next.

By way of example, a TCP socket call from the data fusion processor 240: ATOMIC_CONFLICT_REPLY “myData” trackl setvalues T 0.4 0.1 0.3; is interpreted as: Conflict is for graph “track1” and “mydata” was the user data (this is used to identify the reply to be the response for the n_ATOMIC_CONFLICT command with the same user data.) “0.4” is equal to 1.0−conflict. Therefore the actual conflict is 1.0−0.4=0.6 for the queried variable T. The mass on the vacuous configuration for variable T of “track1” is 0.1 (e.g., the value m_{T}(θ) in Eq. 2), and the mass on vacuous configuration of the input BPA is 0.3 (e.g., the value m_{O}(θ) in Eq. 2) (see example above for n_ATOMIC_CONFLICT).

By way of further example, a TCP socket call to compute the conflict the marginal beliefs on a variable in two tracks, returning a conflict value is represented by: n_ATOMIC_CONFLICT2. This command performs the same conflict calculation as n_ATOMIC_CONFLICT, except that the input basic probability assignment (BPA) is not given in the command, but rather taken from the marginal of the variable <variable name> of another graph <graph name2> in the data fusion processor 240.

TABLE 8
Example Conflict Reply Command Between Existing Tracks

n_ATOMIC_CONFLICT2 <graph name1> <user data>
getvaluations <variable name> <graph name2>;
Computes the marginal BPAs on a given variable in two graphs,
compute and return the conflict of the two marginal BPAs.
<graph name1> = the name of the first graph.
< graph name2 > = the name of the second graph
<user data> = any string data enclosed in double quotes or the token
NULL
<variable name> = name of the variable in both graphs <graph
name1> and <graph name2> to compute the BPA conflict
getvaluations = the token required to perform the conflict
calculation

As in the case of n_ATOMIC_CONFLICT command, an ATOMIC_CONFLICT_REPLY or ATOMIC_CONFLICT_ERROR message is generated from the data fusion processor 240 after it receives this command. When the data fusion processor 240 successfully executes the command, it also sends back n_ATOMIC_CONFLICT_REPLY, as described before. The only difference is that <ignorance mass2> now corresponds to the ignorance mass for the graph <graph name2> rather than the input basic probability assignment.

A summary of an XML file for an example knowledge base and an example fusion network is provided in Table 9. In addition to a description of a variable (e.g., “type”), and associated states (e.g., suv truck gun wheeled_apc_tracked apc howitzer scout_veh), the XML file can identify a type of evidence (e.g., likelihood for “type”), a source of the evidence (e.g., the track processor 225), whether the evidence is discounted according to a confidence, a measure of confidence as in a basic probability assignment ratio (e.g., r=10, corresponding to a discounting factor of 0.9), and an algorithm according to which a basic probability assignment is constructed (e.g., consonant belief or simple). For parametric evidence, the XML file can define ranges, such as those described above in relation to Tables 2A and 2B. For one-to-many mapping, the XML file can define new variables (e.g., “OnOffRoadVehicle”) along with a mapping between variables (e.g., between “OnOffRoadVehicle” and “onroad,” “onandoffroad” and “offroad”).

TABLE 9
Equivalent UIL File for Example
Knowledge Base and Fusion Network

define variable Type {suv truck gun wheeled_apc tracked_apc

howitzer scout_veh};

define variable On_Off_Road {On Off};
define variable OnOffRoadVehicle {onroad offroad

onandoffroad};

define variable Group {ingroup notingroup};
define variable Speed {slow moderate fast};
define variable RCS {small medium large xlarge};
define relation OnOffRoadVehicle-On_Off_Road

{OnOffRoadVehicle On_Off_Road};

define relation Type-OnOffRoadVehicle {Type

OnOffRoadVehicle};

define relation Type-Group {Type Group};
define relation Type-Speed {Type Speed};
define relation Type-RCS {Type RCS};
set valuation Type-OnOffRoadVehicle

{ (truck onroad) (suv onroad)
(howitzer offroad) (tracked_apc offroad)

(gun onandoffroad) (wheeled_apc onandoffroad)
(scout_veh onandoffroad) } 1.0;

# Military veh. are more likely to travel in groups
set valuation Type-Group

{ (truck notingroup) (suv notingroup) (howitzer

ingroup) (tracked_apc ingroup) (wheeled_apc
ingroup) (scout_veh ingroup) (gun ingroup)}
0.9;

# Different veh. travel in different speeds:
set valuation Type-Speed

```
{(suv fast) (suv slow) (suv moderate)
  (howitzer slow)
  (wheeled_apc slow) (wheeled_apc moderate)
  (tracked_apc slow)
  (truck slow) (truck moderate)
  (gun slow)
  (scout_veh slow) (scout_veh moderate)} 1.0;
```

# Different veh. have varying RCS
set valuation Type-RCS

{(suv medium) (gun large) (wheeled_apc medium)

(tracked_apc medium) (truck xlarge) (scout_veh
small) (howitzer small)} 1.0;

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computing device having a display device. The display device can, for example, be a cathode ray tube (CRT) and/or a liquid crystal display (LCD) monitor, and/or a light emitting diode (LED) monitor. The interaction with a user can, for example, be a display of information to the user and a keyboard and a pointing device (e.g., a mouse or a trackball) by which the user can provide input to the computing device (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computing device having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computing devices and having a client-server relationship to each other.

Communication networks can include packet-based networks, which can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

Although the description focuses on a particular example in which sensors 110 generate evidence 115 relating to certain variables and system 100 utilizes the generated evidence 115 to make a particular type of determination, alternative embodiments of system 100 may include sensors 110 capable of generating evidence 115 relating to any appropriate variables and may use this evidence 115 to make any appropriate determination relating to or associated with the monitored object of interest 110. Likewise, although the description focuses on embodiments in which Dempster-Shafer reasoning is used to aggregate evidence 115, alternative embodiments may utilize other evidential reasoning techniques for decision-making

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method to support the tracking of physical objects of interest within a search area, comprising:
receiving evidence related to at least one tracked object of interest;
encoding received evidence into a respective belief function for each of the at least one tracked objects of interest;
assigning an initial degree of belief to each respective belief function, a component of the initial degree of belief being indicative of ignorance; and
forwarding the respective belief function along with the assigned degree of belief, collectively referred to as beliefs, to an evidential reasoning engine for combination and accumulation of beliefs for each of the at least one tracked objects of interest, the evidential reasoning engine updating a belief supporting a respective identity for each of the at least one tracked objects of interest.

2. The method of claim 1, wherein determining a respective belief function further comprises accessing predetermined information relating to one or more of:
at least one system variable indicative of each tracked object of interest;
a plurality of respective states available for association with each of the at least one system variables;
a respective type characterization for the received evidence;
an a priori characterization of the evidence; and
an indication of preferred method for encoding the received evidence.

3. The method of claim 2, further comprising initially storing the predetermined information in an electronic memory.

4. The method of claim 3, wherein the stored information comprises a conditional probability table.

5. The method of claim 3, wherein the stored information comprises a one-to-many structure adapted to provide an equivalence class for association with the received evidence.

6. The method of claim 1, further comprising:
receiving in a format native to a requestor, a request for processing by a separate evidential reasoning engine at least one tracked object of interest;
re-formatting the request, as required, according to a format native to the evidential reasoning engine;
populating the reformatted request with the respective belief function along with the assigned degree of belief; and
forwarding the re-formatted, populated request to the evidential reasoning engine for further processing.

7. The method of claim 6, wherein the request for processing comprises a request for computation of a conflict between two of the at least one tracked objects of interest.

8. The method of claim 6, wherein the request for processing comprises request for merging together into a single tracked object of interest at least two of the at least one tracked objects of interest.

9. The method of claim 1, further comprising maintaining a list of at least one tracked object of interest.

10. The method of claim 1, wherein forwarding the respective belief function along with the assigned degree of belief to the evidential reasoning engine comprises using a TCP/IP socket.

11. The method of claim 1, further comprising discounting the initial degree of belief assigned to each respective belief function.

12. The method of claim 1, further comprising determining, upon request, a conflict between every pair of tracked physical objects of interest.

13. The method of claim 12, wherein the conflict is determined between the encoded belief functions.

14. A system for providing feedback to a track processor to enhance tracking of one or more physical objects of interest within a search area, comprising:
a first electronic memory configurable with predetermined information;
an intermediate processor in communication with the first electronic memory, the intermediate processor adapted to receive evidence related to at least one tracked object of interest, to determine for each of the at least one tracked objects of interest, a respective belief function, and to assign an initial degree of belief to each respective belief function, a component of the initial degree of belief indicative of ignorance;
a second electronic memory configurable with predetermined information relating to a fusion network; and
an evidential reasoning engine in communication with the intermediate processor and the second electronic memory, the evidential reasoning engine adapted for each of the at least one tracked objects of interest, to receive from the intermediate processor the respective belief function along with the assigned degree of belief and in response, to update a belief supporting a respective identity for each of at least one tracked objects of interest.

15. The system of claim 14, further comprising an application program interface adapted to coordinate requests for processing of the at least one tracked object of interest by the evidential reasoning engine, in a format native to a requestor of the processing.

16. The system of claim 14, wherein the evidential reasoning engine comprises evidential reasoning according to the Dempster-Shafer theory of evidence.

17. The system of claim 14, wherein each of the intermediate processor and the evidential reasoning engine comprise a respective TCP/IP socket for communicating there between.

18. The system of claim 14, further comprising network connectivity between the intermediate processor and the evidential reasoning engine.

19. The system of claim 14, wherein the intermediate processor and the evidential reasoning engine are separate devices.

20. A system for enhancing tracking of one or more physical objects of interest within a search area, comprising:
means for receiving evidence related to at least one tracked object of interest;
means for encoding received evidence into a respective belief function for each of the at least one tracked objects of interest;
means for assigning an initial degree of belief to each respective belief function, a component of the initial degree of belief being indicative of ignorance;
means for discounting the assigned initial degree of belief; and
means for forwarding the respective belief function along with the discounted degree of belief, collectively referred to as beliefs, to an evidential reasoning engine for combination and accumulation of beliefs for each of the at least one tracked objects of interest, the evidential reasoning engine updating a belief supporting a respective identity for each of the at least one tracked objects of interest.
